(19) United States
(12) Patent Application Publication
(10) Pub. No.: US 2002/0076554 A1
(43) Pub. Date: Jun. 20, 2002

(54) Composite laminate for personal care product and method of making

(75) Inventor: Steven Ray Stopper, Duluth, GA (US)

Correspondence Address: James B. Robinson, Kimberly-Clark Worldwide, Inc., 401 North Lake Street, Neenah, WI, 54956, US

(73) Assignee: Kimberly-Clark Worldwide, Inc.

(21) Appl. No.: 09/737,928

(22) Filed: Dec. 15, 2000

(51) Int. Cl. B32B 5/18; B32B 5/24; D02G 3/00

(52) U.S. Cl. 428/373; 442/373; 264/173.16; 156/73.1

(57) ABSTRACT

There is provided a personal care product having a composite of a film layer and a coextruded foam layer. The composite is made by extruding the film and foam together. The composite may also have a liner on the side toward the wearer and may have a cover on the backing sheet to make the product more aesthetically pleasing.

### BACKGROUND OF THE INVENTION

The present invention concerns personal care products like diapers, training pants, swim wear, absorbent underpants, adult incontinence products and feminine hygiene products. It is also possible to apply the inventive material and process in other applications such as, for example, in bandages and wound dressings, nursing pads and veterinary applications.

Personal care articles usually have absorbent material of some sort to absorb liquids from the body. This absorbent material or absorbent core is generally made from multiple layers or materials and may include natural fibers, synthetic fibers and superabsorbent particles in varying proportions. The method of making such products, known as “converting”, generally involves the bringing together of a multitude of pre-formed layers. The converting process can be a very impressive operation to see, as materials flow toward the converting machinery from many directions, timed to arrive at the instant needed. As can be imagined, however, the many operations required to assemble a personal care product also create many opportunities for things to go wrong; sensors, motors, and other parts can break, materials may not be replenished rapidly enough, adhesives can gum up machinery, etc. The converting operation also places limitations on the materials that may be used in that they must be relatively thin, and strong enough to withstand the rigors of converting.

There remains a need, therefore, for a personal care product and a method for making it that are more forgiving and simple in their design. A higher degree of flexibility in the choice of materials would be desirable as well as a greater amount of flexibility in the number, thickness and strength of the components of the product. An overall decrease in the degree of complexity for the converting process and for personal care products is needed.

### SUMMARY OF THE INVENTION

In response to the discussed difficulties and problems encountered in the prior art, a new method of making personal care products has been discovered, allowing for the production of new and exciting materials. The products may be made in nearly a one step process a using multi-manifold die as their central step.

### BRIEF DESCRIPTION OF THE DRAWING

FIG. 1 illustrates a cross-sectional view of a mono-layer film.

FIG. 2 illustrates a cross-sectional view of a multilayer stretch-thinned breathable film.

FIG. 3 is a representation of one method of making the novel material of the invention.

### DEFINITIONS

“Disposable” includes being disposed of after a single use and not intended to be washed and reused.

“Liquid communication” means that liquid is able to travel from one layer to another layer, or one location to another within a layer.

“Hydrophilic” describes materials or the surfaces of materials that are wefted by the aqueous liquids in contact with them. The degree of wetting of the materials can, in turn, be described in terms of the contact angles and the surface tensions of the liquids and materials involved. Equipment and techniques suitable for measuring the wettability of particular fiber materials can be provided by a Cahn SFA-222 Surface Force Analyzer System, or a substantially equivalent system. When measured with this system, fibers having contact angles less than 90° are designated “wettable” or hydrophilic, while fibers having contact angles equal to or greater than to 90° are designated “nonwettable” or hydrophobic.

As used herein the term “nonwoven fabric or web” means a web having a structure of individual fibers or threads which are interlaid, but not in an identifiable manner as in a knitted fabric. Nonwoven fabrics or webs have been formed from many processes such as for example, meltblowing processes, spunbonding processes, and bonded carded web processes. The basis weight of nonwoven fabrics is usually expressed in ounces of material per square yard (osy) or grams per square meter (gsm) and the fiber diameters useful are usually expressed in microns. (Note that to convert from osy to gsm, multiply osy by 33.91).

“Spunbonded fibers” refers to small diameter fibers that are formed by extruding molten thermoplastic material as filaments from a plurality of fine capillaries of a spinneret. Such a process is disclosed in, for example, U.S. Pat. No. 4,340,563 to Appel et al. and U.S. Pat. No. 3,802,817 to Matsuki et al. The fibers may also have shapes such as those described, for example, in U.S. Pat. No. 5,277,976 to Hogle et al. which describes fibers with unconventional shapes.

“Bonded carded web” refers to webs that are made from staple fibers which are sent through a combing or carding unit, which separates or breaks apart and aligns the staple fibers in the machine direction to form a generally machine direction-oriented fibrous nonwoven web. This material may be bonded together by methods that include point bonding, through air bonding, ultrasonic bonding, adhesive bonding, etc.

“Airlaying” is a well-known process by which a fibrous nonwoven layer can be formed. In the airlaying process, bundles of small fibers having typical lengths ranging from about 3 to about 52 millimeters (mm) are separated and entrained in an air supply and then deposited onto a forming screen, usually with the assistance of a vacuum supply. The randomly deposited fibers then are bonded to one another using, for example, hot air or a spray adhesive. Airlaying is taught in, for example, U.S. Pat. No. 4,640,810 to Laursen et al.

“Personal care product” means products for the absorption of body exudates. These include diapers, training pants, swim wear, absorbent underpants, adult incontinence products, bandages, veterinary and mortuary products, and feminine hygiene products. These also include surgical products such as gowns and patient drapes.

“Target area” refers to the area or position on a personal care product where an insult is normally delivered by a wearer.

### Test Methods and Materials

Basis Weight: The basis weight may be determined by cutting circular sample of 7.6 cm (3 inches) diameter and weighing using a balance. Weight is recorded in grams. The weight is divided by the sample area.

Material caliper (thickness): The caliper of a material is a measure of thickness and is measured at 0.05 psi (3.5 g/cm²) with a STARRET®-type bulk tester, in units of millimeters.

Density: The density of the materials is calculated by dividing the weight per unit area of a sample in grams per square meter (gsm) by the material caliper in millimeters (mm). The caliper should be measured at 0.05 psi (3.5 g/cm²) as mentioned above. The result is multiplied by 0.001 to convert the value to grams per cubic centimeter (g/cc).

### DETAILED DESCRIPTION OF THE INVENTION

Rather than produce various layers separately in different locations, transport them and bring them together, the instant invention provides a personal care product that is simple in construction and in the method of making.

Modern diapers and other personal care products usually have an outer cover, an inner core portion and a liner that goes against the wearer's skin.

The outer cover or “backsheet” is designed to be impermeable to liquid in order to keep the bedding or clothing of the wearer from becoming soiled.

The liner or “topsheet” is designed to be highly permeable to liquid and to be non-irritating to the skin. More sophisticated types of liners may incorporate lotions or medicaments to improve the environment near the skin or to actually improve skin health.

The core portion of a personal care product is designed to absorb and store liquids and secondarily to distribute liquids and contain solids. The core, known also as an absorbent core, a retention layer, and the like, has been made with pulp and/or superabsorbent materials. These materials absorb liquids quite quickly and efficiently in order to minimize leakage.

Various other layers may be included in current personal care products. These include surge layers, usually placed between the liner and core and designed, as the name suggests, to contain large surges of liquid so that the core may absorb it over time. Distribution layers also are included in many personal care products. Distribution layers are usually located next to the core and accept liquid from the surge or liner layer and distribute it to other areas of the core. In this manner, rather than absorbing liquid exclusively in the vicinity of the target area, more of the absorbent core is used.

The instant invention uses the method of extrusion to produce the personal care product material. A multi-manifold cast film die is used where the first layer is a film layer. The film layer may be cast or blown and may be breathable and made with filler for subsequent stretching to enhance the breathability. Another manifold is used to extrude a foam which may be elastic and which contains superabsorbent particles or absorbent fibers and the like. The amount of superabsorbent in the foam layer is preferably between 5 and 25 weight percent with between 75 and 95 weight percent foam.

This absorbent foam is extruded with the first (film) layer and they exit the die as a single composite layer which may be embossed or allowed to remain flat. A woven or nonwoven layer may be laminated to the absorbent side of the layer by melt lamination or through the use of adhesives and may serve as the liner. Other layers may optionally be added to the liner lamination process to serve as surge, distribution or other layers if so desired, though this adds complexity to the process. Still other layers, like woven or nonwoven layers, may optionally be laminated to the film side of the composite in order to make it more aesthetically pleasing as, for example, a cloth-like outercover.

The composite may then be stretched in the machine or cross-machine (MD or CD) direction or in both directions (biaxially) simultaneously, in order to make the film breathable, and then retracted by the elastic absorbent core.

Thermoforming may be performed on the composite to produce a personal care product having a cup-like, three dimensional shape for packaging. In thermoforming, a material is subjected to heat and pressure in a mold for a time sufficient to make it assume the desired shape. In the case of a diaper, for example, an approximately rectangularly shaped piece of the material of this invention may be thermoformed in a cup-shaped mold after the appropriately sized cutouts are made for the legs. The sides of the diaper will contain seams made from joining at least two parts of the material, e.g., the front and back portions of the diaper. The seams may be overlapping, standing, or edge-to-edge seams and may be sealed by any method known to those skilled in the art, such as ultrasonically or thermally.

Multi-manifold dies are commercially available from Extrusion Dies, Inc., 911 Kurth Road, Chippewa Falls, Wis. 54729-1443 as well as others. Particularly suitable models are sold under the designation ISOFLOW™ Multi-Manifold Coextrusion dies. Another die manufacturer is Cloeren Incorporated, PO Box 2129, Orange, Tex., 77631-2129 which sells dies under the name EPOCH™ IV Multi-Manifold dies.

Suitable film compositions for the outer layer or backsheet include polyethylene film which may have an initial thickness of from about 0.4 mil (0.01 millimeter) to about 5.0 mil (0.12 millimeter). The outer cover may optionally be composed of a vapor or gas permeable, microporous “breathable” material, that is permeable to vapors or gas yet substantially impermeable to liquid. Backings may also serve the function of a mating member for mechanical fasteners.

Breathability can be imparted in polymer films by, for example, using fillers in the film polymer formulation, extruding the filler/matrix polymer formulation into a film and then stretching the film sufficiently to create voids around the filler particles, thereby making the film breathable. Generally, the more filler used and the higher the degree of stretching, the greater the degree of breathability. Other suitable thermoplastic materials like other olefins, nylons, polyesters or copolymers of, for example, polyethylene and polypropylene, polyamides, copolyether esters and polyether block copolymers may also be used. Specific polymers include ones such as PEBAX® and HYTREL® polymers, discussed below, which produce inherently breathable films.

Turning to FIG. 1, it may be seen that the matrix polymer may constitute about 20-95 percent by weight of the breathable monolayer film 10 (or, in the case of multilayer films described below, that percent of the filled film layer). When the film (after stretching, as described below) is desired to have excellent strength and moderate breathability, the matrix polymer may constitute about 55-95 percent by weight of the breathable film or film layer, suitably about 60-80 percent by weight of the breathable film or film layer. In this embodiment, the filler particles 16 may constitute about 5-45 percent of the breathable film or film layer, suitably about 20-40 percent by weight. When the film (after stretching) is desired to have superior breathability and moderate strength, the breathable film or film layer may include about 20 percent to less than 55 percent by weight of the matrix polymer, suitably about 35-50 percent by weight; and more than 45 percent to about 80 percent by weight of the particulate filler, suitably about 50-65 percent by weight.

The filler particles 16 may be inorganic filler particles. Suitable inorganic fillers include without limitation calcium carbonate, clays, silica, alumina, barium sulfate, sodium carbonate, talc, magnesium sulfate, titanium dioxide, zeolites, aluminum sulfate, diatomaceous earth, magnesium sulfate, magnesium carbonate, barium carbonate, kaolin, mica, carbon, calcium oxide, magnesium oxide, aluminum hydroxide and combinations of these particles. The mean diameter for the filler particles 16 should range from about 0.1-10 microns, preferably about 0.5-7.0 microns, most preferably about 0.8-2.0 microns.

The filler particles 16 may also be organic filler particles. Examples of organic filler particles that may be used include particles made of polystyrene, polyamides, polyvinyl alcohol, polyethylene oxide, polyethylene terephthalate, polybutylene terephthalate, polycarbonate, polytetrafluoroethylene, and other suitable polymers and derivatives thereof.

The filler particles 16 may be water-swellable filler particles. By “water-swellable” it is meant that the particles must be capable of absorbing at least about 10 times their weight, preferably at least about 20 times their weight, most preferably at least about 30 times their weight, in distilled water. Examples of organic water-swellable fillers include without limitation natural and synthetic superabsorbent materials. Natural superabsorbent materials include guar gum, agar, pectin and the like. Synthetic superabsorbent materials include hydrogel polymers such as alkali metal salts of polyacrylic acids, polyacrylamides, polyvinyl alcohol, ethylene-maleic anhydride copolymers, polyvinyl ethers, methyl cellulose, carboxymethyl cellulose, hydroxypropylcellulose, polyvinylmorpholinone, and polymers and copolymers of vinyl sulfonic acid, polyacrylates, polyacrylamides, polyvinylpyrridine, and the like. Other suitable polymers include hydrolyzed acrylonitrile grafted starch, acrylic acid grafted starch, and isobutylene maleic anhydride polymers and mixtures thereof. The hydrogel polymers are preferably lightly crosslinked to render the materials substantially water insoluble. Crosslinking may, for example, be accomplished by irradiation or by covalent, ionic, van der Waals, or hydrogen bonding.

The film may be uniaxially or biaxially stretched. The film may be uniaxially stretched to about 1.1-7.0 times its original length, preferably to about 1.5-6.0 times its original length, most preferably to about 2.5-5.0 times its original length. The film may alternatively be biaxially stretched by the same ratios, using conventional techniques familiar to persons skilled in the art. The stretching should occur below the melting temperature of the polymer matrix, suitably about 15-50° F. (8-28° C.) below the melting point of the polymer matrix.

The breathable, stretch-thinned film 10 should have a thickness which facilitates breathability to water vapor, and which also provides structural integrity and liquid barrier. After stretching, the film 10 should have a thickness of about 5-50 microns, preferably about 8-30 microns, most preferably about 10-20 microns. Prior to the orientation, the film 10 can be prepared using cast or blown film extrusion, or another suitable film-forming technique.

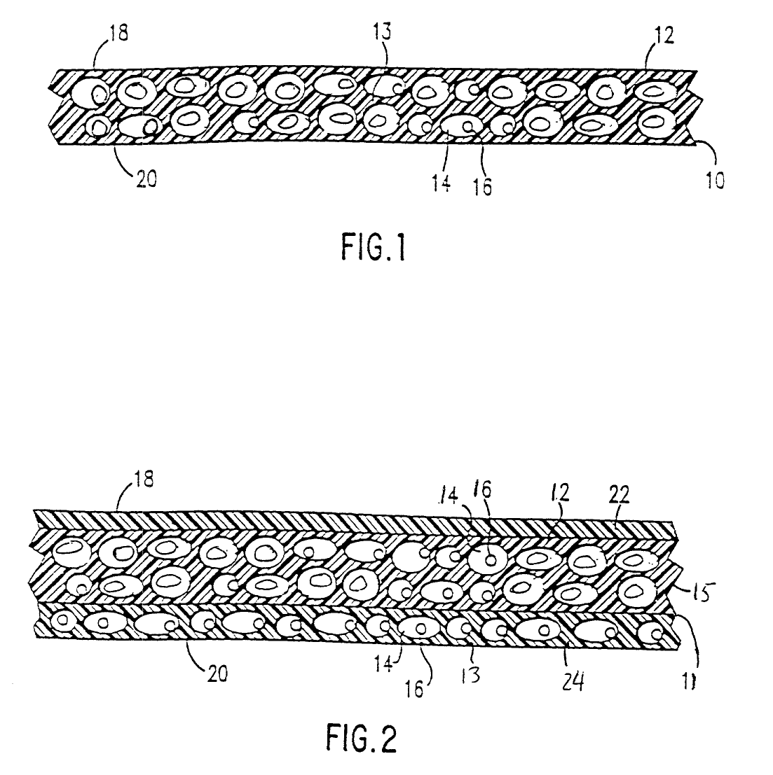

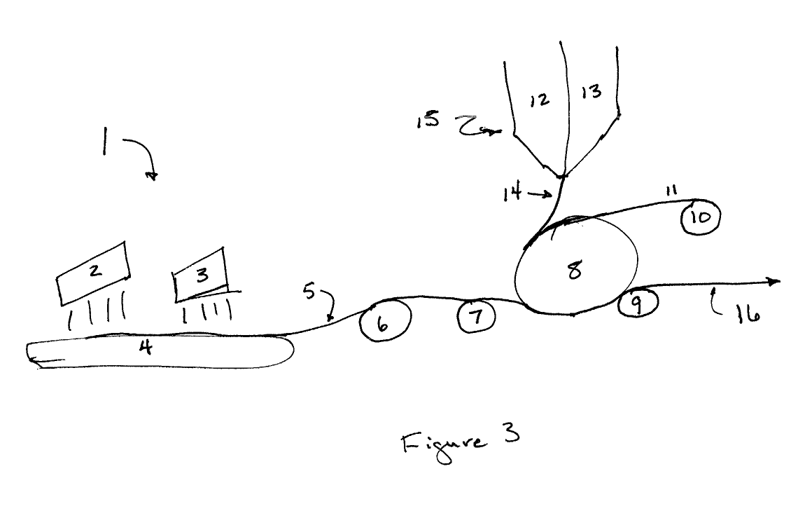

FIG. 2 illustrates another embodiment in which a multilayer stretch-thinned breathable film 11 includes a primary breathable core layer 15 coextruded between two outer skin layers 22 and 24. The core layer 15 includes a polymer matrix 12, and filler particles 16 surrounded by voids 14. The first outer skin layer 22 includes only a thermoplastic polymer, and is free of filler particles and voids. The second outer skin layer 24 includes a polymer matrix 13, and filler particles 16 surrounded by voids 14 within the matrix 13.

The multilayer film 11 in FIG. 2 illustrates that the outer skin layers 22 and 24 may or may not contain a filler. The core layer 15 may have the same or a similar polymer composition to the monolayer film 10 described with respect to FIG. 1. The outer layers 22 and 24 may contain a softer, lower melting polymer or polymer blend which renders the outer layers more suitable as heat seal bonding layers for thermally bonding the film to a nonwoven web. When the outer layer (e.g., 22) is free of filler, one objective is to alleviate the build-up of filler at the extrusion die lip which may otherwise result from extrusion of a filled monolayer film. When the outer layer (e.g., 24) contains filler particles and voids, one objective is to provide a suitable bonding layer without adversely affecting the overall breathability of the film 11.

The thickness and composition of the outer layers 22 and 24 should be selected so as not to substantially impair the moisture transmission through the breathable core layer 15. This way, the breathable core layer 15 may determine the breathability of the entire film, and the outer layers will not substantially reduce or block the breathability of the film. To this end, the skin layers 22 and 24 should be less than about 10 microns thick, suitably less than about 5 microns thick, desirably less than about 2.5 microns thick.

Regardless of whether the breathable stretch-thinned film is a monolayer film or a multilayer film, the overall film should be constructed to function as a breathable microporous film. To function properly, the overall film should have a water vapor transmission rate (WVTR) of at least about 500 grams/m²-24 hours measured using the Mocon procedure described below. Suitably, the overall film should have an WVTR of at least about 1000 grams/m²-24 hours, more suitably at least 2000 grams/m²-24 hours, desirably at least 5000 grams/m²-24 hours. Foam and film compositions that may be used include elastomeric polymers like polyurethanes, copolyether esters, polyamide polyether block copolymers, ethylene vinyl acetates (EVA), block copolymers having the general formula A-B-A′ or A-B like copoly(styrene/ethylene-butylene), styrene-poly(ethylene-propylene)-styrene, styrene-poly(ethylene-butylene)-styrene,(polystyrene/poly(ethylene-butylene)/polystyrene, poly(styrene/ethylene-butylene/styrene) and the like. The elastomeric copolymers are disclosed in, for example, U.S. Pat. No. 4,803,117. The film or foam may be formed from, for example, elastomeric (polystyrene/poly(ethylene-butylene)/polystyrene) block copolymers. Commercial examples of such elastomeric copolymers are, for example, those known as KRATON® materials which are available from KRATON® Chemicals, Inc. (formerly Shell Chemical Company) of Houston, Tex. KRATON® block copolymers are available in several different formulations, a number of which are identified in U.S. Pat. Nos. 4,663,220, 4,323,534, 4,834,738, 5,093,422 and 5,304,599.

Polymers composed of an elastomeric A-B-A-B tetrablock copolymer may also be used in the practice of this invention. Such polymers are discussed in U.S. Pat. No. 5,332,613 to Taylor et al. In such polymers, A is a thermoplastic polymer block and B is an isoprene monomer unit hydrogenated to a substantially a poly(ethylene-propylene) monomer unit. An example of such a tetrablock copolymer is a styrene-poly(ethylene-propylene)-styrene-poly(ethylene-propylene) or SEPSEP elastomeric block copolymer available from the KRATON® Chemicals, Inc. under the trade designation KRATON®.

Other exemplary elastomeric materials which may be used include polyurethane elastomeric materials such as, for example, those available under the trademark ESTANE® from B. F. Goodrich & Co. or MORTHANE® from Morton Thiokol Corp., polyester elastomeric materials such as, for example, those available under the trade designation HYTREL® from E. I. duPont De Nemours & Company, and those known as ARNITEL®, from DSM of Sittard, Holland.

Another suitable material is a polyester block amide copolymer having the formula:

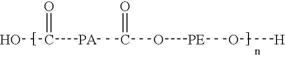

where n is a positive integer, PA represents a polyamide polymer segment and PE represents a polyether polymer segment. Such materials are available in various grades under the trade designation PEBAX® from ELF Atochem Inc. of Glen Rock, New Jersey. Examples of the use of such polymers may be found in U.S. Pat. Nos. 4,724,184, 4,820,572 and 4,923,742, to Killian et al. and assigned to the same assignee as this invention.

The thermoplastic copolyester elastomers include copolyetheresters having the general formula:

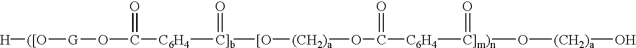

where “G” is selected from the group consisting of poly(oxyethylene)-alpha,omega-diol, poly(oxypropylene)-alpha,omega-diol, poly(oxytetramethylene)-alpha,omega-diol and “a” and “b” are positive integers including 2, 4 and 6, “m” and “n” are positive integers including 1-20. Such materials generally have an elongation at break of from about 600 percent to 750 percent when measured in accordance with ASTM D-638 and a melt point of from about 350 to about 400° F. (176 to 205° C.) when measured in accordance with ASTM D-2117. Commercial examples of such copolyester materials are, for example, those known as ARNITEL®, formerly available from Akzo Plastics of Arnhem, Holland and now available from DSM of Sittard, Holland, or those known as HYTREL® which are available from E.I. duPont de Nemours of Wilmington, Del.

Polyolefins using single site catalysts, sometimes referred to as metallocene catalysts, may also be used. These include ENGAGE® LLDPE polymers from duPont/Dow Elastomers and ACHIEVE® polymers from Exxon Chemical Co.

Biodegradable polymers are also available for film and foam production and suitable polymers include polylactic acid (PLA) and a blend of BIONOLLE®, adipic acid and UNITHOX® (BAU). PLA is not a blend but a pure polymer like polypropylene. BAU represents a blend of BIONOLLE®, adipic acid, and UNITHOX® at different percentages. BIONOLLE® 1020 is polybutylene succinate, BIONOLLE® 3020 is polybutylene succinate adipate copolymer, and UNITHOX® 480 is an ethoxylated alcohol. BIONOLLE® is a trademark of Showa Highpolymer Co. of Japan. UNITHOX® is a trademark of Baker Petrolite which is a subsidiary of Baker Hughes International. It should be noted that these biodegradable polymers are hydrophilic.

Elastic urethane and PVOH foams are also suitable for the production of the foam layer of the composite. Superabsorbent may be added to the foam in the form of particles, fibers and the like. Superabsorbent foams may also be used.

Superabsorbents that are useful in the present inventions can be chosen from classes based on chemical structure as well as physical form. These include superabsorbents with low gel strength, high gel strength, surface cross-linked superabsorbents, uniformly cross-linked superabsorbents, or superabsorbents with varied cross-link density throughout the structure. Superabsorbents may be based on chemistries that include poly(acrylic acid), poly(iso-butylene-co-maleic anhydride), poly(ethylene oxide), carboxy-methyl cellulose, poly(-vinyl pyrrollidone), and poly(-vinyl alcohol). The superabsorbents may range in swelling rate from slow to fast. The superabsorbents may be in the form of foams, macroporous or microporous particles or fibers, particles or fibers with fibrous or particulate coatings or morphology. The superabsorbents may be in the shape of ribbons, particles, fibers, sheets or films. Superabsorbents may be in various length and diameter sizes and distributions. The superabsorbents may be in various degrees of neutralization. Counter-ions are typically Li, Na, K, Ca.

Superabsorbents may be obtained from a number of sources. An Example of these types of superabsorbents may be obtained from Stockhausen, Inc and is designated FAVOR® SXM 880. Other superabsorbents are available from the Dow Chemical Company under the name DRYTECH®.

Binders typically used in these structures help provide mechanical integrity and stabilization. In the case of this invention, binders may be used to adhere the nonwoven liner layer to the composite. If other nonwoven layers are used the binder may be used to bind the layers together. Binders include fiber, liquid or other binder means which may be thermally activated. Preferred binder fibers for inclusion are those having a relatively low melting point such as polyolefin fibers. Lower melting point polymers provide the ability to bond the fabric together at fiber crossover points upon the application of heat. In addition, fibers having a lower melting polymer, like conjugate and biconstituent fibers are suitable for practice of this invention. Fibers having a lower melting polymer are generally referred to as “fusible fibers”. By “lower melting polymers” what is meant are those having a glass transition temperature less than about 175° C. It should be noted that the texture of the absorbent web could be modified from soft to stiff through selection of the glass transition temperature of the polymer. Exemplary binder fibers include conjugate fibers of polyolefins, polyamides and polyesters. Three suitable binder fibers are sheath core conjugate fibers available from KoSa Inc. (Charlotte, N.C.) under the designation T-255 polyethylene/polyethyleneterephathalate and T-256 or Copolyester designation, though many suitable binder fibers are known to those skilled in the art, and are available by many manufacturers such as Chisso Corp. (Japan) and Fibervisions LLC of Wilmington, Del. KoSa has developed a suitable co-polyester binder fiber as a sheath core application and is known by designation T-254 (low melt COPET). A suitable liquid binder is KYMENE® 557LX available from Hercules Inc. of Wilmington, Del. Other suitable liquid binders include ethylene vinyl acetate emulsion polymers sold by National Starch and Chemical Company (Bridgewater, N.J.) under the tradename DUR-O-SET® ELITE® series (including ELITE® 33 and ELITE® 22). Air Products Polymers and Chemicals sells other suitable binder fibers under the name AIRFLEX®.

The fibers used in any fibrous layers in the materials of this invention may be monocomponent, conjugate (bicomponent), multicomponent or biconstituent fibers. If conjugate, they may have side-by-side, sheath/core or islands-in-the-sea configurations. Such fibers may also be hollow or of unconventional (i.e. non-round) shapes. The fibers may be crimped or crimpable according to, for example, U.S. Pat. No. 5,382,400 to Pike.

Other additives may be used in the practice of this invention in order to promote certain properties. Surfactants, for example, may be added to the foam in order to enhance or encourage the passage of urine into the foam for absorption. The surfactant SF-19 from BASF at a level of about 1 weight percent is a suitable surfactant for use in this invention if desired. Hydrophilic polymers may also be added to aid in wetting the superabsorbent. Such polymers include polyvinyl alcohol (PVOH) available under the tradename VINEX®, produced by Texas Polymer Services under license from Air Products and Chemicals.

Turning now to FIG. 3, one sees a conventional nonwoven production line (1) including two banks of spunbond or meltblown fiber dies (2, 3) allowing fibers to fall onto the forming wire (4). This is an example of one method of making the novel material of this invention. The formed nonwoven (5) is conveyed by the rollers (6, 7) to the chill roll (8) where it is united with the composite (14). The composite (14) is made by extruding a film polymer (13) and an elastic foam having superabsorbent (12) in a multi-manifold die extruder (15). The composite (14) is extruded onto the chill roll (8) where it is cooled. As the composite (14) travels around the chill roll (8), the nonwoven, (5) which will serve as the liner in the finished personal care product is joined with it. Another nonwoven layer (11) which may serve as the optional backsheet cover may be unrolled from the storage roll (10) and joined with the composite (14) at the chill roll (8) as well. The finished sandwich (16) having the nonwoven liner (5), composite (14) made with superabsorbent elastic foam (12) and film (13), and optionally, the backsheet cover (11) are conveyed by a roller (9) for further processing or storage.

After the production of the finished sandwich, it may be subjected to conventionally known thermoforming to produce a personal care product having a cup-like, three dimensional shape for packaging.

Examples of suitable absorbent systems according to the invention follow. In all examples the extruder used was a Haake Rheocord 9000 with a 0.75 inch (19.05 mm) screw having an L/D of from 32 to 1 and a compression ratio of 2:1, with a Maddock mixer at the end.

### EXAMPLE 1

Film—A blend of 50 weight percent KRATON® G1730M (a SEPSEP polymer) and 50 weight percent KRATON® FG1901X containing 2 weight percent maleic anhydride was made. The mixture was extruded as a film at a die temperature of 211° C. and a die gap of 0.040 inches (1.02 mm).

Foam—The same KRATON® polymer blend was used. To this blend was added 1 weight percent CELOGEN® 125FF (from Uniroyal Chemical) foaming agent and 20 weight percent Dow DRYTECH® 2035 superabsorbent particles. This superabsorbent had a particle size of 63 to 149 microns. The mixture was extruded at a die temperature of 211° C. at an extruder pressure of 2700 psig, a torque of 8000 mg and 40 revolutions per minute (RPM) of the extruder screw.

Result—The film looked good but the composite was full of holes and very weak.

### EXAMPLE 2

Using 75 weight percent KRATON® G1730M, 25 weight percent KRATON® FG1901X, to which was added 15 weight percent DRYTECH® superabsorbent and 0.75 weight percent CELOGEN® foaming agent.

This foam is less yellow than Example 1, has a rough surface but has strength.

### EXAMPLE 3

Using 90 weight percent KRATON® G1730M, 10 weight percent KRATON® FG1901X, to which was added 15 weight percent of a superabsorbent having a particle size greater than 149 microns and 0.75 weight percent CELOGEN® foaming agent.

This foam looks good. This was laminated using melt lamination with a 20 gsm (0.6 osy) through air bonded bicomponent fiber web and the laminate also looks good.

### EXAMPLE 4

Using 75 weight percent KRATON® G1730M and 25 weight percent VINEX® 2025 polyvinyl alcohol (PVOH) polymer from Texas Polymer Services, Inc., to which was added 15 weight percent of Dow's DRYTECH® 2025 superabsorbent and 0.75 weight percent CELOGEN® foaming agent.

This foam looks good.

The making of a simple personal care product using co-extruded layers to form a composite is thus shown to be possible. A liner may be added to the composite to improve the feeling of the product against the skin of the wearer and the product may be thermoformed into the proper shape.

As will be appreciated by those skilled in the art, changes and variations to the invention are considered to be within the ability of those skilled in the art. Examples of such changes are contained in the patents identified above, each of which is incorporated herein by reference in its entirety to the extent it is consistent with this specification. Such changes and variations are intended by the inventors to be within the scope of the invention.

What is claimed is:

1) A personal care product comprising a composite of a film layer and a co-extruded foam layer.

2) The product of claim 1 wherein said film layer is a breathable film.

3) The product of claim 1 wherein said foam layer comprises superabsorbent.

4) The product of claim 1 wherein said foam comprises elastic polymer in an amount between 75 and 95 weight percent and superabsorbent in an amount between 5 and 25 weight percent.

5) The product of claim 4 wherein said superabsorbent is in a form selected from the group consisting of particles, fibers, and foams.

6) The product of claim 1 further comprising a nonwoven layer adjacent said foam layer.

7) The product of claim 5 wherein said nonwoven layer is selected from the group consisting of spunbond webs, meltblown webs, bonded-carded webs, airlaid webs, and laminates thereof.

8) The product of claim 1 further comprising a nonwoven layer adjacent said film layer.

9) A diaper comprising the composite of claim 1.

10) A training pant comprising the composite of claim 1.

11) An incontinence product comprising the composite of claim 1.

12) A bandage comprising the composite of claim 1.

13) A surgical gown comprising the composite of claim 1.

14) A patient drape comprising the composite of claim 1.

15) A sanitary napkin comprising the composite of claim 1.

16) A personal care product comprising a multilayer laminate including a nonwoven liner layer, co-extruded foam and film layers, and a nonwoven outercover layer.

17) A thermoformed diaper comprising a film layer and a coextruded foam layer, molded for a time under sufficient heat and pressure in a cup-shaped mold.

18) A method of making a composite for personal care products comprising the steps of extruding a film composition and co-extruding therewith a foam composition to form a composite material.

19) The method of claim 18 further comprising the steps of laminating a nonwoven layer to either side of said composite material.

20) The method of claim 18 further comprising the step of thermoforming said composite in a mold having a shape, for a time and under heat and pressure sufficient to cause said composite to maintain the shape of said mold.

21) The method of claim 20 further comprising the step of sealing a seam formed by at least two parts of said composite.

22) The method of claim 21 wherein said seam is sealed ultrasonically.
